(19) United States
(12) Patent Application Publication
(10) Pub. No.: US 2026/0225358 A1
(43) Pub. Date: Aug. 6, 2026

(54) BARRIER FILM FOR PACKAGING MATERIAL

(71) Applicant: Stora Enso OYJ, Helsinki (FI)

(72) Inventors: Anna Kauppi, Lappeenranta (FI); Juha Korvenniemi, Oriniemi (FI); Isto Heiskanen, Imatra (FI); Kaj Backfolk, Lappeenranta (FI)

(73) Assignee: Stora Enso OYJ, Helsinki (FI)

(21) Appl. No.: 19/128,845

(22) PCT Filed: Nov. 8, 2023
(86) PCT No.: PCT/IB2023/061255

§ 371 Date: May 9, 2025

(30) Foreign Application Priority Data
Nov. 11, 2022 (SE) 2230363-0

(51) Int. Cl. B32B 29/02

(52) U.S. Cl. CPC B32B 29/02; B32B 2255/02; B32B 2255/26; B32B 2262/062; B32B 2307/7244; B32B 2307/7265; B32B 2553/00

(57) ABSTRACT

The present invention relates to a barrier film for a paper or paperboard-based packaging material, said barrier film comprising cellulosic fibers and highly refined cellulose wherein the barrier film comprises less than 50 wt-% of highly refined cellulose based on the total fiber content and the barrier film having an air permeance above 2000 pm/Pas and a geometric mean tensile index above 70 Nm/g. The invention also relates to a paper or paperboard-based packaging material comprising the barrier film and a method for producing said film.

### TECHNICAL FIELD

The present disclosure relates to a barrier film for paper and paperboard based packaging materials. More specifically, the present disclosure relates to barrier films based on highly refined cellulose, preferably microfibrillated cellulose having good barrier properties and at the same time improved mechanical properties. The present invention further relates to paper and paperboard based packaging materials comprising such barrier films and to methods for manufacturing such barrier film.

### BACKGROUND

Coating of paper and paperboard with plastics is often done to combine the mechanical properties of the paperboard with the barrier and sealing properties of a plastic film. Paperboard provided with even a relatively small amount of a suitable plastic material can provide the properties needed to make the paperboard suitable for many demanding applications, for example as liquid packaging board. In liquid packaging board, polyolefin coatings are frequently used as liquid barrier layers, heat sealing layers and adhesives. Aluminum foils are also often used to give the needed barrier properties.

In many cases, the gas, light and moisture barrier properties of the polymer coated paperboard are still insufficient. Therefore, in order to ensure acceptable gas, light and moisture barrier properties, the polymer coated paperboard is often provided with one or more layers of aluminum foil. However, the addition of polymer and aluminum layers add significant costs and makes recycling of the materials more difficult. Also, due to its high carbon footprint there is a wish to replace aluminum foils in packaging materials in general, and in liquid packaging board in particular.

More recently, microfibrillated cellulose (MFC) films and coatings have been developed, in which defibrillated cellulosic fibrils have been dispersed e.g. in water and thereafter re-organized and rebonded together to form a dense film with excellent gas barrier properties. Unfortunately, dense MFC films and extensive densification processes reduces the mechanical properties of MFC films, which makes their impact on stiffness in paper or paperboard laminates less beneficial as well as converting more challenging. A densification process using finer fibers and fibrils leads to longer dewatering times and higher risk of variations in air permeance.

Thus, there remains a need for improved solutions to replace plastic films and aluminum foils in packaging materials, while maintaining acceptable liquid and barrier properties. At the same time, there is a need to replace the plastic films and aluminum foils with renewable films that improves the mechanical properties of the laminate and facilitate re-pulping, recycling and reuse of the used packaging materials.

### DESCRIPTION OF THE INVENTION

It is an object of the present disclosure to provide an alternative to the plastic films and aluminum foils commonly used as barrier films for providing liquid and oxygen barrier properties in packaging materials, such as liquid packaging board.

It is a further object of the present disclosure to provide a barrier film for paper or paperboard based packaging materials and liquid packaging board, which improves the mechanical properties of the materials.

It is a further object of the present disclosure, to provide a barrier film comprising highly refined cellulose, which has improved barrier properties and improved mechanical and strength properties.

It is a further object of the present invention to be able to increase the production speed of the barrier film and still be able to produce a film with good barrier properties.

The above-mentioned objects, as well as other objects as will be realized by the skilled person in the light of the present disclosure, are achieved by the various aspects of the present disclosure.

According to a first aspect illustrated herein, there is provided a barrier film for a paper or paperboard-based packaging material, wherein said barrier film comprising cellulosic fibers and highly refined cellulose wherein the barrier film comprises less than 50 wt-% of highly refined cellulose based on the total fiber content and the barrier film having an air permeance above 2000 pm/Pas and a geometric mean tensile index above 70 Nm/g.

The air permeance was measured according to ISO 5636-1 using L&W Code 168 air permeance tester (pm/Pa*s at 20 kPa). The barrier film preferably has the mentioned air permeance on at least one side of the barrier film, i.e. either on the top side (ts) or the back side (bs), preferably on the top side. The tensile index is calculated from the tensile strength.

The tensile strength is measured according to SCAN-P 67. The tensile index in CD and MD is thereafter calculated by dividing the tensile strength in respective direction with the grammage of the film. The geometric mean (GM) tensile index is calculated based on the tensile index in MD and CD according to (MD×CD)^{1/2}.

The invention is based on the surprising realization that it was possible to provide a barrier film suitable for coating to give excellent barrier properties and with good strength properties with addition of only low amounts of highly refined cellulose. It was also surprising that the uncoated barrier film does not need to have good oxygen barrier properties but after application of a polymer coating, especially a water soluble polymer, the coated barrier film will have excellent barrier properties. Consequently, the barrier film according to the invention is suitable to coat and to form a coated film with excellent oxygen barrier properties.

It may be preferred that the barrier film has an air permeance above 3000 pm/Pas, preferably above 5000 pm/Pas or even more preferred above 10 000 (which is the Max value for air permeance measurements). This air permeance value of the multilayer barrier film before addition of any eventual polymer layers. Higher air permeance value means that the barrier film has decreased oxygen barrier properties. It has surprisingly been found that addition of small amounts of highly refined cellulose made it possible to produce a strong barrier film that is suitable for coating and the coated barrier film has shown to have excellent barrier properties.

It may be preferred that the barrier film as a geometric mean (GM) tensile index above 71 Nm/g, even more preferred above 72 Nm/g. The increased tensile index value of the film shows that the barrier film has good mechanical properties and can handle mechanical process steps such as converting, coating and calendering without breaking and thus destroying the barrier properties of the film.

The barrier film may further comprise a polymer barrier layer comprising a water soluble polymer forming a coated barrier film. It is preferred to use polyvinyl alcohol (PVOH), polyurethane, styrene polyacrylates, ethylene acrylic acid, polysaccharides such as starch, starch alignate, hemicellulose, chitosan, cellulose or derivatives of mentioned polysaccharides or mentioned polymers. Polyvinyl alcohol (PVOH) is the preferred polymer which has shown to give excellent barrier properties.

It is preferred that the coated barrier film has an oxygen transmission rate (OTR), measured according to the standard ASTM F1927-20 at 50% relative humidity and 23° C., of less than 5 cc/m²/24 h, preferably below 3 cc/m²/24 h and even more preferred below 1 cc/m²/24 h. It has been found that it is possible to add small amounts of polymer to the barrier layer and be able to produce a coated film with excellent barrier properties.

The barrier film of the present invention is suitable for applying a polymer coating, preferably a water soluble polymer coating. The suspension or dispersion comprising said water soluble polymer coating, preferably PVOH, preferably has a water retention value above 50 gsm, preferably above 100 gsm, even more preferred above 125 gsm, more preferably above 150 gsm measured according to TAPPI T701 pm-01. The high water retention value means that the suspension or dispersion will release more water to the barrier film. The barrier film of the present invention is surprisingly suitable for such polymer coating since it is less sensitive to wetting and water penetration compared to e.g. a pure HRC film.

The grammage of the polymer barrier layer is preferably below 15 gsm, preferably between 0.5-10 gsm and even more preferred between 1.5-5 gsm. It has surprisingly been found that it is sufficient to add only small amounts of polymer and still be able to produce a barrier film with very good barrier properties.

The barrier film preferably comprises between 50-95 wt-%, preferably between 60-90-% or even more preferred between 70-85 wt-% of cellulosic fibers based on the total fiber content of the barrier film.

The cellulosic fibers preferably have a Schopper Riegler value between 15-45, as determined by standard ISO 5267-1, more preferably between 20-35. The cellulosic fibers are preferably fibers from either hardwood or softwood pulp. The pulp can be pulp from virgin fiber, e.g. mechanical, chemical, chemithermomechanical and/or thermomechanical pulps. It may be preferred that the cellulosic fibers are made from kraft pulp, more preferably bleached kraft pulp. The barrier film preferably comprises between 50-95 wt-% of cellulosic fibers based on the total fiber content of the barrier film, preferably between 60-90 wt-% and even more preferred between 70-85 wt-%.

The cellulosic fibers are preferably gentle refined to improve the formation behavior, drainage and infiltration of highly refined cellulose into the film. The cellulosic fibers are preferably refined to the mentioned SR value using a specific edge load (SEL) below 1.5 J/m, preferably below 1.4 J/m and even more preferred below 1.3 J/m. It may be preferred to use different SEL values for different pulp types. For hardwood pulps, e.g. eucalyptus bleached kraft pulp and birch bleached kraft pulp, it is preferred to use a SEL value below 1.0 J/m, preferably below 0.75 J/m and more preferred lower than 0.65 J/m. For softwood pulp, such as pine or spruce bleached kraft pulps, it is preferred to use a SEL value below 1.5 J/m, preferably below 1.4 J/m and even more preferred below 1.3 J/m. The specific edge load theory is based on the idea that all the refining energy is transferred to the fibers by the bar edges during refining. The specific edge load describes the refining intensity and its calculated according to formula:

$$SEL = \frac{{P}_{tot} - {P}_{0}}{n \times {Z}_{r} \times {Z}_{st} \times l} = \frac{{P}_{net}}{n \times CLF} = \frac{{P}_{net}}{CEL}$$

where:
SEL specific edge load (J/m);
Pₜₒₜ total load power (kW);
P₀ no-load power (kW);
Pₙₑₜ net refining power (kW);
n rotation speed (revs/s);
Zᵣ number of rotor bars;
Zₛₜ number of stator bars;
l bar length (km);
CEL cutting edge length (km/s);
CLF cutting length factor (km/rev).

The barrier film preferably comprises between 5-50 wt-%, preferably between 10-40 wt-%, preferably between 5-30 wt-%, preferably between 10-30 wt-% or even more preferred between 15-30 wt-% of highly refined cellulose based on the total fiber content of the barrier film.

The highly refined cellulose (HRC) is preferably produced from a cellulose pulp suspension by subjecting the pulp to refining. The highly refined cellulose comprises cellulose particles, fibers or fibrils. The HRC can be produced from wood cellulose fibers, both from hardwood or softwood fibers. It can also be made from microbial sources, agricultural fibers such as wheat straw pulp, bamboo, bagasse, or other non-wood fiber sources. It can be made from pulp, including pulp from virgin fiber, e.g. mechanical, chemical and/or thermomechanical pulps. The pulp may be bleached or unbleached. It can also be made from broke or recycled paper.

The highly refined cellulose preferably have a Schopper Riegler value above 70, as determined by standard ISO 5267-1, even more preferably above 80, and even more preferred above 85.

The highly refined cellulose is preferably microfibrillated cellulose (MFC). It is preferred that the microfibrillated cellulose has a Schopper Riegler (SR) value above 85, preferably above 90 and even more preferred above 95. The SR value is measured according to standard ISO 5267-1. It was found that even small amounts of MFC is sufficient to provide a barrier film with both improved barrier and strength properties. It is preferred to use native MFC i.e. that the MFC is produced from non-chemically modified pulp (after pulp plant).

Microfibrillated cellulose (MFC) shall in the context of the patent application mean a cellulose particle, fiber or fibril having a width or diameter of from 20 nm to 1000 nm.

Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose.

MFC can be produced from wood cellulose fibers, both from hardwood or softwood fibers. It can also be made from microbial sources, agricultural fibers such as wheat straw pulp, bamboo, bagasse, or other non-wood fiber sources. It can be made from pulp, including pulp from virgin fiber, e.g. mechanical, chemical and/or thermomechanical pulps. The pulp may be bleached or unbleached. It can also be made from broke or recycled paper.

The barrier film preferably has a basis weight between 20-120 gsm, preferably between 25-90 gsm and most preferably between 30-85 gsm. This is the total basis weight of the barrier film, i.e. the total basis weight for all layers of the film, if the film comprises more than one layer.

The barrier film may be a multiply barrier film. It may be preferred that the barrier film comprises more than one layers and forms a multiply structure. The multiply barrier film may comprise of two, three, four, fix, six or even more layers. The layers are preferably attached to each other in wet state, i.e. wet webs are couched together followed by drying to form said multiply barrier film. The multiply barrier film may be symmetrical or non-symmetrical meaning that either the same composition is used in all layers, i.e. a symmetrical structure, or that different compositions are used in at least two of the layers giving the barrier film a non-symmetrical structure. A non-symmetrical structure can be designed to reduce problems with e.g. curl of the final dried product. It has been found that the production of a high barrier film at high production speed is easier achieved if a multiply barrier film is produced. By the use of thinner layers the dewatering speed of each ply can be increased and the couching of the different layers together will still make it possible to produce a multiply structure with very good barrier properties, even if each ply per se does not have that good barrier properties. It is also possible to laminate the different layers together to form said multiply barrier film.

The barrier film preferably has a stretch in the cross-direction of at least 5%, preferably at least 5.5% and even more preferred above 6%. It has been found that higher stretch is required to improve the converting processes by enabling faster converting and reduced risk for web breaks and cracks during converting. Also, it is believed that higher stretch provides a better formability of the barrier film. The stretch refers to the percentage elongation of the barrier film before rupture as measured according to standard tensile test IS01924-2.

The barrier film preferably has a geometric mean tensile stiffness of at least 300 kN/m, preferably at least 320 kN/m and even more preferred at least 350 kN/m. This is preferably the value of the barrier film before addition of any eventual polymer layers. It has been found that increased tensile stiffness will provide for a stronger barrier film that will withstand converting and mechanical process steps in an improved way. It has also been found that the use of the barrier film with improved tensile stiffness in a paper or paperboard based packaging material makes it possible to reduce the amount of fibers in the final material, i.e. it enables source reduction of the final packaging material. Furthermore, the improved tensile stiffness enables the use of recycled pulp or use of a higher amount of broke pulp to be used. The tensile stiffness is measured according to standard SCAN-P 67.

The geometric mean (GM) tensile stiffness is calculated based on the tensile stiffness in MD and CD according to (MD×CD)^{1/2}.

The barrier film preferably has a geometric mean (GM) Tensile Energy Absorption (TEA) index of at least 1.5 J/g. The TEA is measured according to standard SCAN-P 67. The TEA index is calculated by dividing the TEA value with the grammage (for both CD and MD). The geometric mean TEA index is then calculated based on the TEA index in MD and CD according to (MD×CD)^{1/2}. This is preferably the value of the barrier film before addition of any eventual polymer layers.

Another advantage with the barrier film according to the invention is that the shrinkage of the film during drying is reduced. It is very important that the film does not shrink too much during drying since it will affect the properties of the film. It is preferred that the drying shrinkage in cross-direction of the film is below 7%, preferably below 6% and even more preferred below 5%. The drying shrinkage is measured as the difference in width (CD) of the web in the wire section and before the reeler. The dry solid content of the web at the wire section if normally below 15% and the dry solid content of the web before reeler is normally above 90%.

It is preferred that the bursting strength of the barrier film is at least 130 kPa, preferably at least 140 kPa and even more preferred at least 150 kPa measured according to ISO 2759. This is preferably the value of the barrier film before addition of any eventual polymer layers. The bursting strength of the film is an important feature which makes the converting and handling of the barrier film easier without rupturing or damaging the film and thus destroying the barrier properties of the film.

It is preferred that more than 95% by weight of the barrier film is cellulose based. This is the amount of cellulose in the barrier film before addition of any eventual polymer layers. Consequently, the barrier film of the present invention is manly cellulose based. In this was a sustainable and renewable barrier film is produced which can be used to replace fossil-based barrier materials. Using a cellulose based barrier film is especially useful for use in paper or paperboard laminates since the laminate can be recycled as a single material.

The barrier film may comprise recycled fibers. It may be possible that the barrier film comprises 1-50 wt % of recycled fibers based on the total fiber content of the barrier film. With recycled fibers is meant fibers from post consumed products.

The barrier film preferably has a repulpability characterized by a reject rate (as determined according to the PTS R. H 021/97 test method) of below 15%, preferably below 10% and even more preferred below 5%. This is preferably the value of the barrier film before addition of any eventual polymer layers. A big advantage with the present invention is that it has very high repulpability properties. Barrier films comprising high amounts of MFC or nanocellulose can be difficult to re-use for example as broke in paper or paperboard manufacturing processes since ti negatively will affect the consistency and viscosity of the added broke. The barrier film of the present invention has good barrier and strength properties at the same time as it is possible to re-cycle and re-use in new cellulose based products.

The barrier film preferably has a Schopper Riegler value below 90, preferably below 85 and even more preferred below 80 after being disintegrated. The low amount of highly refined cellulose in the barrier film makes it easier to disintegrate the barrier film and re-use it. The SR value of the disintergrated barrier film is preferably quite low which makes it much easier to re-use the barrier film after usage. The SR value was measured according to IS05267-1.

The inventive barrier film may preferably be used as a barrier layer in a paper or paperboard based packaging material, particularly in packaging board, liquid packaging board (LPB), paper pouches or paper or paperboard tubes or cups, for use in the packaging of liquids or liquid containing products. Therefore, according to a second aspect illustrated herein, there is provided a paper or paperboard based packaging material comprising a paper or paperboard base layer; and a barrier film as described herein. It has been found that the barrier film according to the present invention is an excellent barrier and can be used as a sustainable barrier to reduce the amount of polymer used or to replace the polymer or aluminum-based layers.

The barrier film of the paper or paperboard based packaging material according to the second aspect may be further defined as set out above with reference to the first aspect.

Paper generally refers to a material manufactured in thin sheets from the pulp of wood or other fibrous substances comprising cellulose fibers, used for writing, drawing, or printing on, or as packaging material. With paper base layer is meant the cellulosic paper layer of a paper packaging material.

Paperboard generally refers to strong, thick paper or cardboard comprising cellulose fibers used for boxes and other types of packaging. Paperboard can either be bleached or unbleached, coated or uncoated, and produced in a variety of thicknesses, depending on the end use requirements. With paperboard base layer is meant the cellulosic paperboard layer of the paperboard based packaging material.

A paper or paperboard-based packaging material is a packaging material formed mainly, or entirely from paper or paperboard. In addition to paper or paperboard, the paper or paperboard-based packaging material may comprise additional layers or coatings designed to improve the performance and/or appearance of the packaging material.

In some embodiments, the barrier film is laminated onto the base layer using an adhesive polymer layer disposed between the base layer and the barrier film. Thus, in some embodiments the paper or paperboard based packaging material further comprises an adhesive polymer layer, e.g. a tie layer, disposed between the base layer and the barrier film.

The inventive barrier film or the paper or paperboard based packaging material is preferably realized without any extrusion coated or lamination coated polyolefin coatings often used in barrier layers for liquid packaging materials. Instead, the inventive barrier film preferably uses materials, which are more easily separated from the from the fibrous paper and paperboard materials and thereby facilitates re-pulping of the board. However, it is of course also possible to combine the inventive barrier film with a conventional extrusion coated or lamination coated polyolefin coating layer.

The inventive barrier film can be used to manufacture a paper or paperboard based packaging material having an oxygen transmission rate (OTR), measured according to the standard ASTM D-3985 at 85% relative humidity and 38° C., of less than 10 cc/m²/24 h, preferably less than 5 cc/m²/24 h and even more preferred less than 1 cc/m²/24 h.

The inventive barrier film can further be used to manufacture a paper or paperboard based packaging material which is recyclable and may provide a reject rate according to PTS RH 021/97 of less than 30%, preferably less than 20%, more preferably less than 10%.

The paper or paperboard preferably has a basis weight in the range of 20-500 gsm, preferably in the range of 80-400 gsm and it preferably has a density between 350-850 kg/m³ measured according to ISO 534.

The paper or paperboard based packaging material may further comprise at least one outer polymer layer. The outer polymer layer may of course interfere with repulpability, but may still be required or desired in some applications. The outer polymer layer may for example be applied by extrusion coating, film lamination or dispersion coating. The outer polymer layer can be a coating layer to improve the barrier properties and to give the barrier film heat-sealing properties. The outer polymer layer may also be a tie layer used to improve the adhesion of the barrier film to another substrate, such as a paper or paperboard substrate. The outer polymer layer is preferably applied to the surface of the barrier film so that a coated paper or paperboard based packaging layer is formed. It is preferred that that the barrier film is located between the paper or paperboard base layer and the outer polymer layer of said coated paper or paperboard based packaging material. The other side of the paper or paperboard base layer not in contact with the barrier film may also be polymer coated with an outer polymer layer to provide the paper or paperboard based packaging material with additional barrier, printing and heat-sealable properties.

The outer polymer layer may comprise any of the thermoplastic polymers commonly used in paper or paperboard based packaging materials in general or polymers used in liquid packaging board in particular. Examples include polyethylene (PE), polyethylene terephthalate (PET), polypropylene (PP), polyhydroxyalkanoates (PHA), polylactic acid (PLA), polybutylene succinate (PBS), polyethylene furanoate (PEF), polyvinyl alcohol (PVOH), acrylates, styrene/butadiene, polyvinyl acetate, or polyglycolic acid (PGA). Polyethylenes, especially low density polyethylene (LDPE) and high density polyethylene (HDPE), are the most common and versatile polymers used in liquid packaging board.

The basis weight of the outer polymer layer is preferably less than 40 gsm. In order to achieve a continuous and substantially defect free film, a basis weight of the polymer layer of at least 5 gsm, preferably at least 10. In some embodiments, the basis weight of the polymer layer is in the range of 5-40 gsm, preferably in the range of 5-20 gsm, preferably between 10-15 gsm.

The paper or paperboard based packaging material being coated with a polymer layer preferably has an oxygen transmission rate (OTR), measured according to the standard ASTM D-3985 at 85% relative humidity and 38° C., of less than 1 cc/m²/24 h, preferably less than 0.5 cc/m²/24 h and even more preferred less than 0.2 cc/m²/24 h. It has been found that the combination of the barrier film according to the invention and the coating barrier layer makes it possible to provide a coated film with excellent oxygen barrier properties.

The paper or paperboard based packaging material may further comprise a metallized or vacuum deposited metal or metal oxide layer, preferably applied by physical vapor deposition (PVD) or chemical vapor deposition (CVD). The metallized layer preferably comprises a metal or metal oxide selected from the group consisting of aluminum, magnesium, silicon, copper, aluminum oxides, magnesium oxides, silicon oxides, and combinations thereof, preferably aluminum.

Generally, while the products, polymers, materials, layers and processes are described in terms of “comprising” various components or steps, the products, polymers, materials, layers and processes can also “consist essentially of” or “consist of” the various components and steps.

According to a third aspect illustrated herein, there is provided a method for manufacturing a barrier film for a paper or paperboard based packaging material, comprising the steps of:
a) providing a first suspension comprising cellulose fibers,
b) providing a first suspension comprising highly refined cellulose,
c) mixing said first suspension comprising cellulose fibers and said first suspension comprising highly refined cellulose to form a first mixture wherein said mixture comprises less than 50 wt % of highly refined cellulose based on total fiber content,
d) applying said first mixture to a first substrate,
e) dewatering said mixture on said substrate to form a first wet web
f) drying and optionally pressing said wet web to form said barrier film wherein said barrier film has an air permeance above 2000 pm/Pas and a geometric mean tensile index above 70 Nm/g.

The barrier film according to the third aspect may be further defined as set out above with reference to the first aspect.

The drying and optionally pressing can be done by any known used equipment. Drying may for example be done by passing the web around a series of heated drying cylinders. Drying may typically remove the water content down to a level of about 1-15 wt %, preferably to about 2-10 wt %. Pressing may be done in any suitable pressing equipment either before or after drying of said barrier film.

The first and/or second substrate may be a non-porous substrate or a porous substrate. The use of non-porous substrates, such as polymer or metal substrate is normally used in formation of the barrier film by use of casting technologies, followed by drying with evaporation. Alternatively, the film can be made by applying a suspension on a porous substrate forming a web followed by dewatering of the web by draining water through the substrate for forming the film. The porous substrate may for example be a membrane or wire fabric. Formation of the web can be accomplished e.g. by use of a paper- or paperboard machine type of process.

The method according to the third aspect may further comprise the steps of:
i) proving a second suspension providing comprising cellulose fibers,
ii) providing a second suspension comprising highly refined cellulose,
iii) mixing said second suspension comprising cellulose fibers and said second suspension comprising highly refined cellulose to form a second mixture wherein said second mixture comprises less than 50 wt % of highly refined cellulose based on total fiber content,
iv) applying said second mixture to a second substrate,
v) dewatering said second mixture on said second substrate to form a second wet web
vi) applying said second wet web onto said first wet web forming a multiply web
vii) drying and optionally pressing said multiply web to form a multiply barrier film.

In this way a multiply barrier film is produced. It has been found that it is possible to produce a barrier film with good barrier and strength properties which film comprises low amounts of highly refined cellulose by couching two or more wet webs together to form a multiply barrier film. ed together followed by drying to form said multiply barrier film.

The weight ratio between the first web and the second web is preferably from 30:70 to 70:30, even more preferred between 40:60 to 60:40. The multiply barrier film may be symmetrical, i.e. having a weight ratio of 50:50 or non-symmetrical meaning that the weight ratio is different between the two webs. A non-symmetrical structure can be designed to reduce problems with e.g. curl of the final dried product. It has been found that the production of a high barrier film at high production speed is easier achieved if a multiply barrier film is produced.

The first and/or second mixture preferably has a Schopper Riegler value between 65-95, preferably between 70-85 and even more preferably between 75-80 as determined by standard ISO 5267-1. It has been found that too high SR value will affect the repulpabiltiy and the strength properties of the barrier film in a negative way. However, the use of a pulp mixture with too low SR value will not be able to give the desired barrier properties.

The first and/or second mixture preferably has a water retention value between 150-290% and more preferably between 160-270% and even more preferably between 170-250% measured according to SCAN 62:00.

The method according to the third aspect may further comprise the step of applying a polymer barrier layer to at least one side of the barrier film to form a coated barrier film. The polymer barrier layer preferably comprises PVOH.

The method according to the third aspect may further comprise the step of applying an outer polymer layer to at least one side of the barrier film. The outer polymer layer may comprise any of the thermoplastic polymers commonly used in paper or paperboard based packaging materials in general or polymers used in liquid packaging board in particular. Examples include polyethylene (PE), polyethylene terephthalate (PET), polypropylene (PP), polyhydroxyalkanoates (PHA), polylactic acid (PLA), polybutylene succinate (PBS), polyethylene furanoate (PEF), polyvinyl alcohol (PVOH), acrylates, styrene/butadiene, polyvinyl acetate, or polyglycolic acid (PGA). Polyethylenes, especially low density polyethylene (LDPE) and high density polyethylene (HDPE), are the most common and versatile polymers used in liquid packaging board.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

### Examples

Different bleached hardwood and softwood kraft pulps were combined with highly refined cellulose (HRC) having a SR value >95. The hardwood (birch) was slightly refined to a SR of 30 while the softwood (Pine) was refined to a SR of 33 as determined according to the standard. The HRC was made from bleached kraft pulp without using derivatization chemicals.

A multiply forming technology was used to prepare 2-ply webs by using two headboxes and two wires. Retention and drainage chemicals (microparticles), strength additives (starch) were added to the furnishes, whereas its impact on drainage behavior as measured from mixing chest was not significant. Target was to make 20+20 multiply sheets, whereas change in grammage was made partly to explore the process window. pH for the furnishes were about 7.0 (6.5-7.5).

### Example 1—Comparative

A 2-ply web was prepared by using 100% HRC in both layers. As seen from the Schopper Riegler value as determined from the mixing chest, the drainage resistance is very high. The obtained 2-ply web has low air permeance, i.e. is porous which is ascribed to the high drainage resistance and subsequent formation of pinholes and web defects.

### Example 2—Comparative, Replacing HRC in Back Ply with Coarse Fibers

In this case, part of the MFC in the back ply was replaced with coarse fibers (30 wt % hardwood, 30 wt % softwood and 40 wt % HRC). The total amount of HRC in this example were almost 70%. The results shows that the drainage resistance decreases from 96 to 86, and that a more dense sheet is being obtained. However, the mechanical properties, especially Tensile index, TEA are not significantly improved. In fact, burst strength and tensile stiffness (GM) are reduced.

### Example 3—Comparative, Replacing HRC in Back Ply with Coarse Fibers

In this case, a similar solution as in previous example was made but now with only softwood kraft pulp and HRC in the back-ply. The total amount of HRC in this example were almost 70%. No improvements in the properties were obtained.

### Example 4—Reduced HRC Amount, Non-Symmetrical Structure

In this case, the total amount of HRC in the structure was further reduced to less than 50 wt % (47 wt %) based on the total amount of cellulose in the substrate.

Also, the weight ratio of top ply to back ply was changed from 50:50 to about 40:60. In this case, there was a clear improvement in especially TEA GM Index and tensile index and the air permeability, which shows that it is possible to produce a film with improved barrier and strength properties with the use of less highly refined cellulose.

Furthermore, the shrinkage of the web was found to decrease which is very beneficial when producing a barrier film.

### Example 5—Low Content of HRC, Symmetrical Structure

In this case, the total amount of HRC in the structure was reduced to 30 wt %. In this case, the structure is uniform. Despite the reduced HRC amount, the SR value determined from machine chests are much lower than reference points but still high confirming a high drainage resistance (77).

Despite the significantly lower amount of HRC, the obtained product is very dense, i.e. high air permeance resistance and high tensile index.

Also, the shrinkage of the web was decreased.

TABLE I
Web compositions

| Trial points | | 1 | 2 | 3 | 4 | 5 |
|---|---|---|---|---|---|---|
| Top ply | gsm | 20 | 18 | 18 | 18 | 27.5 |
| HRC | % | 100 | 100 | 100 | 70 | 30 |
| Birch - SR 30 | % | | | | 30 | 35 |
| Pine - SR 33 | % | | | | | 35 |
| Back ply | gsm | 20 | 18 | 18 | 25 | 28 |
| HRC | % | 100 | 40 | 40 | 30 | 30 |
| Birch - SR 30 | % | | 30 | | 70 | 35 |
| Pine - SR 33 | % | | 30 | 60 | | 35 |

TABLE II
Furnish and web properties

| Trial points | | 1 | 2 | 3 | 4 | 5 |
|---|---|---|---|---|---|---|
| Mixing chest, Top ply - °SR | °SR | 95.0 | | | 92.5 | 78.0 |
| Mixing chest, Back ply - °SR | °SR | 96.0 | 85.0 | 84.0 | 77.0 | 77.0 |
| Solids content after wire | % | 15.9 | 17.2 | 17.5 | 17.9 | 19.2 |
| Solids content after 3rd press | % | 25.8 | 28.4 | 28.5 | 29.0 | 33.2 |
| Drying shrinkage | % | 9.1 | 8.5 | 8.6 | 5.8 | 6.5 |

TABLE III
Physical properties of film

| Property | Unit | 1 | 2 | 3 | 4 | 5 |
|---|---|---|---|---|---|---|
| Grammage | gsm | 41.3 | 36.8 | 37.9 | 43.6 | 55.4 |
| Thickness, single sheet | μm | 54 | 46 | 50 | 51 | 68 |
| Density, single sheet | kg/m³ | 761 | 801 | 762 | 852 | 812 |
| Tensile index, MD | Nm/g | 94.11 | 94.57 | 94.97 | 97.53 | 96.78 |
| Tensile index, CD | Nm/g | 48.79 | 52.42 | 48.72 | 54.57 | 62.48 |
| Tensile index GM | | 68 | 70 | 68 | 73 | 78 |
| Stretch, CD | % | 3.7 | 5 | 4.2 | 5.9 | 7.2 |
| Tensile stiffness GM | kN/m | 320.91 | 288.87 | 294.18 | 330.25 | 421.23 |
| TEA index, MD | J/g | 1.258 | 1.082 | 0.88 | 1.452 | 1.285 |
| TEA index, CD | J/g | 1.458 | 2.041 | 1.581 | 2.474 | 3.245 |
| TEA GM index | | 1.35 | 1.49 | 1.18 | 1.90 | 2.04 |
| Bursting strength | kPa | 140 | 116 | 119 | 147 | 197 |
| Air permeance, ts | pm/Pas | 3.3 | 4041.8 | 2459.2 | 10000 | 10000 |
| Air permeance, bs | pm/Pas | 2.2 | 3072 | 1794.2 | 10000 | 10000 |

### Example 6a and 6b (Coating)

In this case, the web from examples 1 and 4, respectively, were used for applying a thin barrier coating onto the top ply side. A water-based solution comprising 100 wt % Polyvinyl alcohol was prepared and applied at low coat weights (3 gsm) onto the substrates before drying.

The OTR (oxygen transmission rate) for the reference substrate 1 was 6.1 cc/m2/24 h when determined at 23° C./50% RH (average for two samples). The corresponding value for sample 4, which had initially a significantly higher air permeance value, was 4.6 cc/m2/24 h (23° C./50% RH), despite that the starting material was more porous.

1. A barrier film for a paper or paperboard-based packaging material, said barrier film comprising:
cellulosic fibers and highly refined cellulose, wherein the barrier film comprises less than 50 wt-% of highly refined cellulose based on a total fiber content, and
wherein the barrier film has an air permeance above 2,000 pm/Pas and a geometric mean tensile index above 70 Nm/g.

2. The barrier film according to claim 1, wherein the barrier film further comprises a polymer barrier layer forming a coated barrier film, the polymer barrier layer comprising polyvinyl alcohol (PVOH), polyurethane, styrene polyacrylates, ethylene acrylic acid, polysaccharides, starch alignate, hemicellulose, chitosan, cellulose, or derivatives of of any of the foregoing.

3. The barrier film according to claim 2, wherein the coated barrier film has an oxygen transmission rate (OTR), measured according to standard ASTM F1927-20 at 50% relative humidity and 23° C., of less than 5 cc/m²/24 h.

4. The barrier film according to claim 2, wherein a grammage of the polymer barrier layer is below 15 gsm.

5. The barrier film according to claim 1, wherein the barrier film comprises between 5-50 wt-% of highly refined cellulose based on the total fiber content of the barrier film.

6. The barrier film according to claim 1, wherein the cellulosic fibers have a Schopper Riegler value between 15-45, as determined by standard ISO 5267-1.

7. The barrier film according to claim 1, wherein the highly refined cellulose has a Schopper Riegler value above 70, as determined by standard ISO 5267-1.

8. The barrier film according to claim 1, wherein the highly refined cellulose is microfibrillated cellulose (MFC).

9. The barrier film according to claim 1, wherein the barrier film has a basis weight between 20-120 gsm.

10. The barrier film according to claim 1, wherein the barrier film is a multiply barrier film.

11. The barrier film according to claim 1, wherein the barrier film has a stretch in cross-direction of at least 5%.

12. The barrier film according to claim 1, wherein the barrier film has a geometric mean tensile stiffness of at least 300 kN/m.

13. The barrier film according to claim 1, wherein the barrier film has a geometric mean Tensile Energy Absorption (TEA) index of at least 1.5 J/g.

14. The barrier film according to claim 1, wherein the drying shrinkage in cross-direction of the film is below 7%.

15. A paper or paperboard based packaging material comprising:
a paper or paperboard base layer; and
the barrier film according to claim 1.

16. The paper or paperboard based packaging material according to claim 15, wherein the paper or paperboard has a basis weight in a range of 20-500 gsm.

17. The paper or paperboard based packaging material according to claim 15, further comprising:
an outer polymer layer attached to the barrier film so that the barrier film is located between the paper or paperboard base layer and the outer polymer layer.

18. The paper or paperboard packaging material according to claim 17, wherein the outer polymer layer comprises polyethylene (PE), polyethylene terephthalate (PET), polypropylene (PP), polyhydroxyalkanoates (PHA), polylactic acid (PLA), polybutylene succinate (PBS), polyethylene furanoate (PEF), polyvinyl alcohol (PVOH), acrylates, styrene,_/butadiene, polyvinyl acetate, or polyglycolic acid (PGA).

19. A method for manufacturing a barrier film for a paper or paperboard based packaging material, comprising the steps of:
a) providing a first suspension comprising cellulose fibers,
b) providing a first suspension comprising highly refined cellulose,
c) mixing said first suspension comprising cellulose fibers and said first suspension comprising highly refined cellulose to form a first mixture wherein said first mixture comprises less than 50 wt % of highly refined cellulose based on a total fiber content,
d) applying said first mixture to a first substrate,
e) dewatering said first mixture on said substrate to form a first wet web, and,
f) drying and optionally pressing said wet web to form a barrier film wherein said barrier film has an air permeance above 2,000 pm/Pas and a geometric mean tensile index above 70 Nm/g.

20. The method according to claim 19, wherein the method further comprises the steps of:
i) proving a second suspension providing comprising cellulose fibers,
ii) providing a second suspension comprising highly refined cellulose,
iii) mixing said second suspension comprising cellulose fibers and said second suspension comprising highly refined cellulose to form a second mixture wherein said second mixture comprises less than 50 wt % of highly refined cellulose based on a total fiber content,
iv) applying said second mixture to a second substrate,
v) dewatering said second mixture on said second substrate to form a second wet web,
vi) applying said second wet web onto said first wet web forming a multiply web, and
vii) drying and optionally pressing said multiply web to form a multiply barrier film.

21. (canceled)

22. (canceled)

23. (canceled)
